(19) United States
(12) Patent Application Publication
(10) Pub. No.: US 2026/0261298 A1
(43) Pub. Date: Sep. 3, 2026

(54) BEAMFORMING

(71) Applicant: Nokia Solutions and Networks Oy, Espoo (FI)

(72) Inventors: Nuan SONG, Shanghai (CN); Stefan WESEMANN, Stuttgart (DE); Olli Juhani PIIRAINEN, Oulu (FI); Tao YANG, Shanghai (CN); Yan ZHAO, Shanghai (CN)

(21) Appl. No.: 18/881,647

(22) PCT Filed: Jul. 7, 2022
(86) PCT No.: PCT/CN2022/104392

§ 371 Date: Jan. 6, 2025

(51) Int. Cl. H04B 7/06

(52) U.S. Cl. CPC H04B 7/0617; H04B 7/06952

(57) ABSTRACT

Embodiments of the present disclosure relate to a device, method, apparatus and computer readable storage medium for beamforming. A first device determines a first set of candidate horizontal beams by consecutively transforming an initial horizontal beam vector by a horizontal channel covariance matrix. The first device determines a second set of candidate vertical beams by consecutively transforming an initial vertical beam vector by a vertical channel covariance matrix. The first device determines a beamforming matrix for communication with a second device based on a first subset of the first set and a second subset of the second set.

### FIELD

Embodiments of the present disclosure generally relate to the field of telecommunication and, in particular, to a device, method, apparatus and computer readable storage medium for beamforming.

### BACKGROUND

Multiple input multiple output (MIMO) technology is considered as one powerful scheme to achieve high data throughputs in a communication system. MIMO refers to the type of wireless transmission and reception scheme where both a transmitter and a receiver employ more than one antenna.

Massive MIMO is a type of MIMO system with a very large number of antennas (for example, greater than an 8×8 array). Further, massive MIMO combined with beamforming can deliver a high spatial multiplexing gain and a large beamforming gain, which is considered as one key feature of the fifth generation (5G) new radio (NR) to enhance the system spectral efficiency. The sixth generation (6G) radio may provide an even higher capacity to support a large number of users. The mid-band spectrum (such as 7 GHz to 20 GHz) will be combined with an extreme massive MIMO antenna array at a network device and a larger antenna array at a terminal device can provide around 20 times more capacity compared to 5G.

In the massive MIMO system, the transmitter may use a beamforming matrix to perform related transmission or reception. However, currently, the calculation amount for generating the beamforming matrix is high.

### SUMMARY

Example embodiments of the present disclosure provide a solution for beamforming.

In a first aspect, there is provided a first device. The first device comprises at least one processor and at least one memory including computer program codes. The at least one memory and the computer program codes are configured to, with the at least one processor, cause the first device to: determine a first set of candidate horizontal beams by consecutively transforming an initial horizontal beam vector by a horizontal channel covariance matrix; determine a second set of candidate vertical beams by consecutively transforming an initial vertical beam vector by a vertical channel covariance matrix; and determine a beamforming matrix for communication with a second device based on a first subset of the first set and a second subset of the second set.

In a second aspect, there is provided a method. The method comprises: determining, at a first device, a first set of candidate horizontal beams by consecutively transforming an initial horizontal beam vector by a horizontal channel covariance matrix; determining a second set of candidate vertical beams by consecutively transforming an initial vertical beam vector by a vertical channel covariance matrix; and determining a beamforming matrix for communication with a second device based on a first subset of the first set and a second subset of the second set.

In a third aspect, there is provided an apparatus. The apparatus comprises: means for determining, at a first device, a first set of candidate horizontal beams by consecutively transforming an initial horizontal beam vector by a horizontal channel covariance matrix; means for determining a second set of candidate vertical beams by consecutively transforming an initial vertical beam vector by a vertical channel covariance matrix; and means for determining a beamforming matrix for communication with a second device based on a first subset of the first set and a second subset of the second set.

In a fourth aspect, there is provided a computer readable medium. The non-transitory computer readable medium comprises program instructions for causing an apparatus to perform the method according to the second aspect.

It is to be understood that the summary section is not intended to necessarily identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example implementations will now be described with reference to the accompanying drawings, where:

FIG. 1 illustrates an example distribution of antenna elements in a uniform planar array with cross-polarization in accordance with some example implementations of the present disclosure;

FIG. 2 illustrates a signaling flow of an Independent Eigen Beamforming (I-EBF) procedure;

FIG. 3 illustrates an example communication environment in which embodiments of the present disclosure can be implemented;

FIG. 4 illustrates a flowchart of an example method implemented at a first device in accordance with some example embodiments of the present disclosure;

FIG. 5 illustrates a block diagram of a machine learning (ML) based clustering module in accordance with some example embodiments of the present disclosure;

FIGS. 6, 7 and 8 illustrate a signaling chart illustrating a process for determining initial horizontal and vertical beam vectors, respectively;

FIG. 9 illustrates a frame architecture to show an example implementation of the beamforming procedure in accordance with some example implementations of the present disclosure;

FIGS. 10 A and 10B illustrate spectral efficiency performance of various schemes for beamforming, respectively;

FIGS. 11A, 11B and 11C illustrate computational complexity for different schemes using different sizes of the matrix, respectively;

FIG. 12 illustrates a simplified block diagram of an apparatus that is suitable for implementing example implementations of the present disclosure; and

FIG. 13 illustrates a block diagram of an example computer readable medium in accordance with example implementations of the present disclosure.

Throughout the drawings, the same or similar reference numerals represent the same or similar element, unless otherwise provided.

### DETAILED DESCRIPTION

Principles of the present disclosure will now be described with reference to some example implementations. It is to be understood that these implementations are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as, but not limited to, fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT), Wi-Fi and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned systems.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

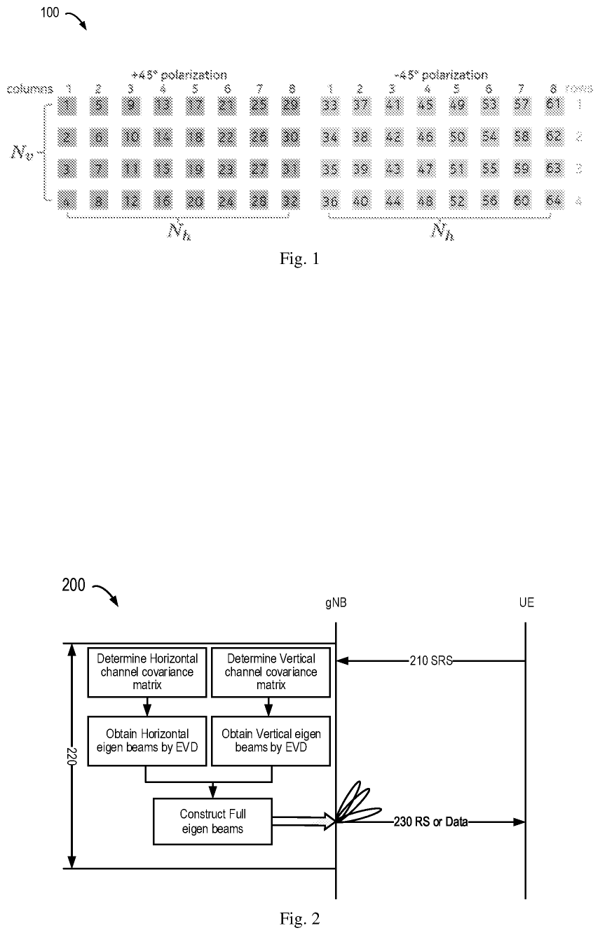

A network device may be configured with an extreme massive MIMO antenna array. FIG. 1 illustrates an example distribution of antenna elements in a uniform planar array 100 with cross-polarization for a network device in accordance with some example implementations of the present disclosure. As shown in FIG. 1, the uniform planar array 100 comprises Nₕ antenna elements in horizontal domain and Nᵥ antenna elements in vertical domain. For example, Nₕ may be equal to 8 and Nᵥ may be equal to 4.

As described above, a transmitter of a network device may use a beamforming matrix to perform related transmission or reception. However, currently, the calculation amount for generating the beamforming matrix is high. This will be described with reference to FIG. 2.

FIG. 2 illustrates a signaling chart illustrating a process 200 for an I-EBF procedure. As illustrated in FIG. 2, a UE transmits 210 SRS to a gNB, and the gNB performs 120 an I-EBF procedure based on the received SRS. Specifically, the gNB determines a horizontal channel covariance matrix and a vertical channel covariance matrix based on the received SRS, respectively. Then, the gNB obtains horizontal and vertical independent eigen beams by applying Eigen Value Decomposition (EVD) on the horizontal channel covariance matrix and the vertical channel covariance matrix, respectively. In turn, the gNB constructs full eigen beams by selecting and combining independent eigen beams.

The implementation of the I-EBF procedure may have some limitations. For example, the I-EBF procedure can only be uplink SRS based. In addition, the I-EBF procedure based on an iterative power method can be advantageous over the pure EVD implementation, but the computational complexity can be still high due to iterations and orthogonalization procedure.

In order to solve the above and other potential problems, embodiments of the present disclosure provide a solution for beamforming. In the solution, a first device determines a first set of candidate horizontal beams by consecutively transforming an initial horizontal beam vector with a horizontal channel covariance matrix and determines a second set of candidate vertical beams by consecutively transforming an initial vertical beam vector by a vertical channel covariance matrix. In turn, the first device determines a beamforming matrix for communication with a second device based on a first subset of the first set and a second subset of the second set. In this way, a beamforming procedure with a lower computational complexity is achieved.

Some example embodiments of the present disclosure will now be described in detail with reference to the figures. However, those skilled in the art would readily appreciate that the detailed description given herein with respect to these figures is for explanatory purpose as the present disclosure extends beyond theses limited embodiments.

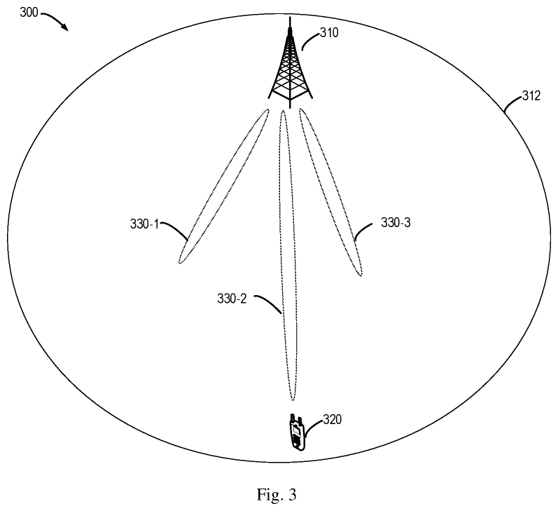

FIG. 3 illustrates an example communication environment 300 in which example embodiments of the present disclosure can be implemented. In the communication environment 300, a first device 310 may communicate with a second device 320 via physical communication channels or links. Further, the first device 310 may communicate with the second device 320 via different beams to enable a directional communication. In the example of FIG. 3, beams 330-1 to 330-3 are illustrated by way of example. Further, although not shown, the second device 320 also supports to use a plurality of beams to communicate with the first device 310.

In this example, the first device 310 is illustrated as a gNB and the second device 320 is illustrated as a UE. Hereinafter, some embodiments will be described by taking the gNB and the UE as an example. However, in other embodiments, the first device 310 may be implemented as other devices than the gNB. For example, the first device 310 may be implemented as a relay, an AP, or an RRH. In other embodiments, the second device 320 may be implemented as other devices than the UE. For example, the second device 320 may be implemented as a station, a tablet, or a wearable device.

In embodiments where the first device 310 is implemented as a gNB, a serving area of the first device 310 is called as a cell 312. It is to be understood that the number of gNBs and UEs is only for the purpose of illustration without suggesting any limitations. The environment 300 may include any suitable number of gNBs and UEs adapted for implementing embodiments of the present disclosure. Although not shown, it would be appreciated that one or more UEs may be located in the cell 312 and served by the first device 310.

In this example, a link from the second device 320 to the first device 310 is referred to as uplink (UL), while a link from the first device 310 to the second device 320 is referred to as a downlink (DL). In DL, the first device 310 is a transmitting (TX) device (or a transmitter) and the second device 320 is a receiving (RX) device (or a receiver). The first device 310 may transmit DL transmission to the second device 320 via one or more beams. As illustrated in FIG. 3, the first device 310 may transmit DL transmission to the second device 320 via the beams 330-1 to 330-3. In UL, the first device 310 is a RX device (or a receiver) and the second device 320 is a TX device (or a transmitter).

The communications in the environment 300 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the 5G and 6G communication protocols.

It is to be understood that the numbers their connections of first device, second device, beam and cell, and are only for the purpose of illustration without suggesting any limitations. The communication environment 300 may include any suitable number of the first device, the second device, beams and cells adapted for implementing embodiments of the present disclosure. Although not shown, it is to be understood that one or more additional first devices and second devices may be located in the respective cells. It would also be appreciated that in some examples, only the homogeneous network deployment or only the heterogeneous network deployment may be included in the environment 300.

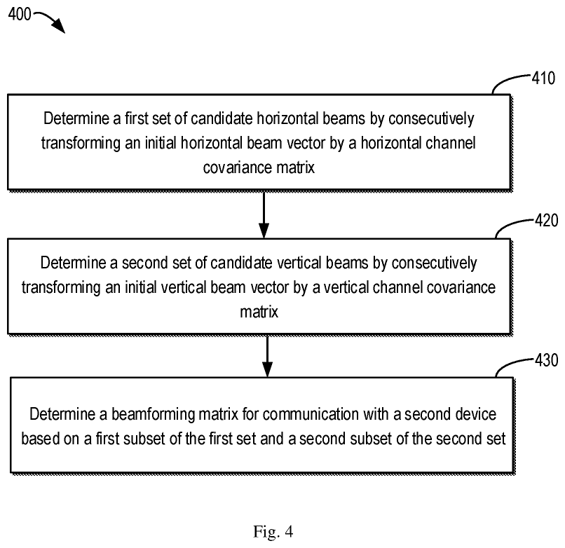

FIG. 4 illustrates a flowchart of an example method 400 implemented at a first device in accordance with some example embodiments of the present disclosure. For the purpose of discussion, the method 400 will be described from the perspective of the first device 310 with reference to FIG. 3. It would be appreciated that the method 300 may also be implemented at the second device 320 in FIG. 1.

At block 410, the first device 310 determines a first set of candidate horizontal beams by consecutively transforming an initial horizontal beam vector by a horizontal channel covariance matrix.

At block 420, the first device 310 determines a second set of candidate vertical beams by consecutively transforming an initial vertical beam vector by a vertical channel covariance matrix.

At block 430, the first device 310 determines a beamforming matrix for communication with the second device 320 based on a first subset of the first set and a second subset of the second set.

With the method 400, a beamforming procedure with a lower computational complexity may be achieved.

For the purpose of illustration, Table 1 shows an algorithm implementation of the beamforming procedure in accordance with some example embodiments of the present disclosure.

TABLE 1

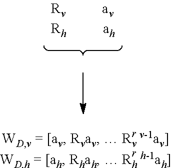

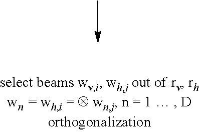

In Table 1, aᵥ represents the initial vertical beam vector, aₕ represents the initial horizontal beam vector, Rᵥ represents the vertical channel covariance matrix, Rₕ represents the horizontal channel covariance matrix, W_{D,v} represents the second set of candidate vertical beams, W_{D,h} represents the first set of candidate horizontal beams, w_{v,j} represents a candidate vertical beam in the second subset, w_{h,i} represents a candidate horizontal beam in the first subset, and wₙ represents a beamforming vector in the beamforming matrix.

In some embodiments, upon determining the beamforming matrix, the first device 310 may transmit a reference signal (RS) or data to the second device 320 by using the beamforming matrix. For example, the first device 310 may process the RS or data using the beamforming matrix and transmit the processed RS or the processed data to the second device 320.

Alternatively, upon determining the beamforming matrix, the first device 310 may process an RS or data received from the second device 320 by using the beamforming matrix so as to improve a success rate of decoding the received RS or data.

### Trigger of the Beamforming Procedure of the Present Disclosure

In some embodiments, the beamforming procedure of the present disclosure may be referred to as a first beamforming procedure. For example, any of the beamforming procedures described with reference to FIGS. 4, 6, 7 and 8 may be referred to as the first beamforming procedure.

In some embodiments, in order to determine whether to apply the first beamforming procedure to the second device 320, the first device 310 may determine a first association between uplink channel information previously received from a third plurality of devices and predetermined beamforming procedures to be applied to the third plurality of devices. The predetermined beamforming procedures comprise the first beamforming procedure.

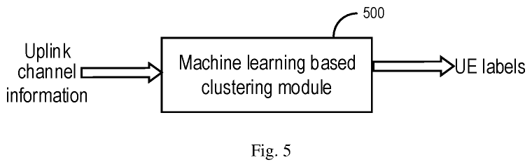

For example, the first device 310 may apply a machine learning (ML) algorithm to cluster the third plurality of devices (for example, UEs) in a dynamic and low-complexity way. When the second device 320 requests for an initial access to the first device 310, instead of re-computing new metrics for all UEs, the first device 310 may determine, based on the first association and uplink channel information received from the second device 320, the first beamforming procedure among the predetermined beamforming procedures which is to be applied to the second device 320. In turn, the first device 310 may determine the at least one of the first set of candidate horizontal beams and the second set of candidate vertical beams by performing the first beamforming procedure. This will be described with reference to FIG. 5.

FIG. 5 illustrates a block diagram of an ML based clustering module 500. As shown in FIG. 5, the first device 310 may apply the ML based clustering module 500. During training of the ML based clustering module 500, an input of the ML based clustering module 500 is uplink channel information received from a plurality of UEs and an output of the ML based clustering module 500 is UE labels. Each of the UE labels is associated with one of the predetermined beamforming procedures. The ML based clustering module 500 may be trained according to a loss function of minimization of total squared error over all clusters.

After the training or UE labeling, the first device 310 selects the serving UEs (such as 5G or 6G UEs, high data rate required) to implement the first beamforming procedure. When the second device 320 requests for an initial access, the first device 310 may apply the ML based clustering module 500 to dynamically cluster the second device 320 without recalculating and re-clustering all existing UEs, which reduces the complexity and latency.

### Determination of the Initial Horizontal and Vertical Beam Vectors

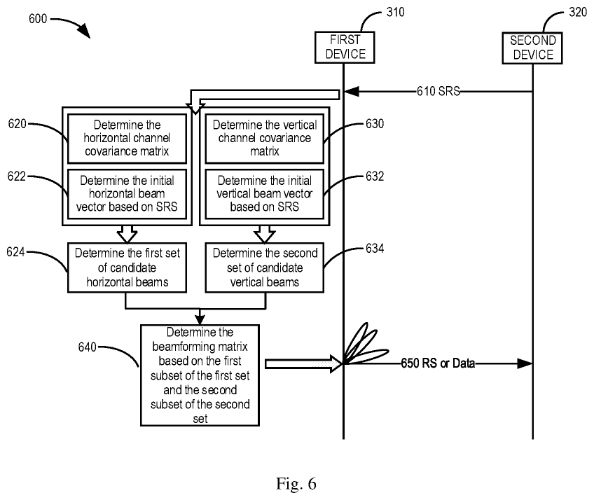

FIG. 6 illustrates a signaling chart illustrating a process 600 for determining the initial horizontal and vertical beam vectors. The process 600 will be described with reference to the communication environment 300 of FIG. 3. However, this process may be likewise applied to other communication scenarios.

As shown in FIG. 6, the first device 310 receives 610 an RS from the second device 320. For example, the RS may comprise a sounding reference signal (SRS). The SRS may be periodically transmitted or triggered based on the channel quality.

In turn, the first device 310 determines 620 a horizontal channel covariance matrix based on the received RS. In addition, the first device 310 determines 622 an initial horizontal beam vector based on the received RS. Then, the first device 624 determines a first set of candidate horizontal beams by consecutively transforming the initial horizontal beam vector by the horizontal channel covariance matrix.

On the other hand, the first device 310 determines 630 a vertical channel covariance matrix based on the received RS. In addition, the first device 310 determines 632 an initial vertical beam vector based on the received RS. Then, the first device 310 determines 634 a second set of candidate vertical beams by consecutively transforming the initial vertical beam vector by the vertical channel covariance matrix.

Then, the first device 310 determines 640 a beamforming matrix for communication with the second device 320 based on a first subset of the first set and a second subset of the second set.

In turn, the first device 310 processes the RS or data using the beamforming matrix and transmits 650 the processed RS or the processed data to the second device 320.

Because the process 600 does not need feedback of the second device 320, overhead will be reduced.

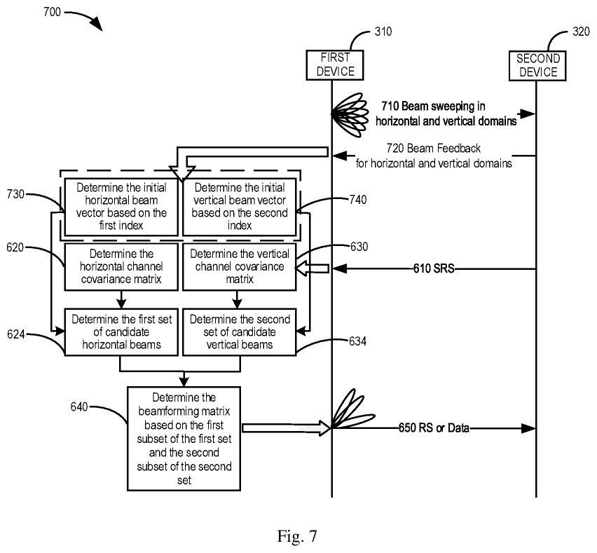

FIG. 7 illustrates a signaling chart illustrating a process 700 for determining the initial horizontal and vertical beam vectors. The process 700 will be described with reference to the communication environment 300 of FIG. 3. However, this process may be likewise applied to other communication scenarios.

As shown in FIG. 7, the process 700 is different from the process 600 in that the initial horizontal and vertical beam vectors are determined based on beam feedback from the second device 320.

Specifically, the first device 310 performs 710 a horizontal beam sweeping and a vertical beam sweeping to the second device 320. The first device 310 may perform the horizontal beam sweeping and the vertical beam sweeping by transmitting a plurality of horizontal beams and a plurality of vertical beams to the second device 320, respectively.

The second device 320 may select a best horizontal beam from the plurality of horizontal beams as the initial horizontal beam and a best vertical beam from the plurality of vertical beams as the initial vertical beam. Then, the second device 320 transmits 720 a beam feedback to the first device 310. The beam feedback comprises a first index of the initial horizontal beam vector and a second index of the initial vertical beam vector.

Upon receiving the first index of the initial horizontal beam vector and the second index of the initial vertical beam vector, the first device 310 determines, at block 730, the initial horizontal beam vector based on the first index and determines, at block 740, the initial vertical beam vector based on the second index.

The actions at blocks 610, 620, 624, 630, 634, 640 and 650 in the process 700 are the same as those in the process 600. Details of these actions are omitted for brevity.

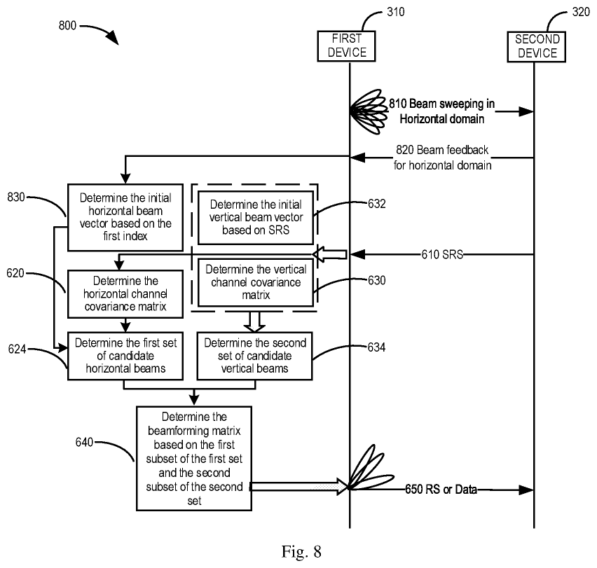

FIG. 8 illustrates a signaling chart illustrating a process 800 for determining the initial horizontal and vertical beam vectors. The process 800 will be described with reference to the communication environment 300 of FIG. 3. However, this process may be likewise applied to other communication scenarios.

As shown in FIG. 8, the process 800 is different from the process 700 in that the initial horizontal beam vector is determined based on a beam feedback from the second device 320 and the initial vertical beam vector is determined based on the SRS received from the second device 320.

Specifically, the first device 310 performs 810 a horizontal beam sweeping to the second device 320. The first device 310 may perform the horizontal beam sweeping by transmitting a plurality of horizontal beams to the second device 320.

The second device 320 may select a best horizontal beam from the plurality of horizontal beams as the initial horizontal beam. Then, the second device 320 transmits 820 a beam feedback to the first device 310. The beam feedback comprises the first index of the initial horizontal beam vector.

Upon receiving the first index of the initial horizontal beam vector, the first device 310 determines, at block 830, the initial horizontal beam vector based on the first index.

The actions at blocks 610, 620, 624, 630, 632, 634, 640 and 650 in the process 800 are the same as those in the process 600. Details of these actions are omitted for brevity.

The process 800 may trade-off the performance and complexity.

In some embodiments, in order to determine the initial vertical beam vector, the first device 310 may perform a vertical beam sweeping to the second device 320. In turn, the first device 310 may receive, from the second device 320, the second index of the initial vertical beam vector. Then, the first device 310 may determine the initial vertical beam vector based on the second index. In such embodiments, the first device 310 may determine the initial horizontal beam vector based on the SRS received from the second device 320.

In some embodiments, the first device 310 may select one of the processes 600, 700 and 800 to implement based on at least one of the following: the subframe timing, computational complexity, RS resources, and performance requirements.

In the process 700 or 800, the beam sweeping may be implemented either by Synchronization Signal Block (SSB) in an initial access or by the triggered aperiodic Channel State Information Reference Signal (CSI-RS) procedure based on channel quality.

It shall be noted that the processes 600, 700 and 800 of the present disclosure are different from the process 200 for the I-EBF procedure in that not only the horizontal and vertical channel covariance matrices are required, but also the initial horizontal and vertical beam vectors are required.

In addition, the processes 700 and 800 of the present disclosure are different from the process 200 for the I-EBF procedure in that the beam feedback from the second device 320 is used to assist the beamforming procedure.

### Determination of the Horizontal and Vertical Channel Covariance Matrices

As described with reference to FIGS. 6 to 8, in some embodiments, the horizontal and vertical channel covariance matrices may be determined based the SRS received from the second device 320. Hereinafter, details of the determination of the horizontal and vertical channel covariance matrices will be described with reference to FIG. 1.

As mentioned above, FIG. 1 illustrates the example distribution of antenna elements in a uniform planar array 100 with cross-polarization for a network device. In some embodiments, the first device 310 may be configured with the uniform planar array 100 with cross-polarization.

We denote a channel vector per PRB as hₖ(t, f)∈ [symbol] ^{N}^{ₕ}^{N}^{ᵥ}^{N}^{ₚₒₗ}, where Nₕ, N_{y}, and Nₚₒₗ correspond to the number of columns, the number of rows, and the number of polarizations in the array 100, respectively. The horizontal channel covariance matrix averaged over rows, both two polarizations, and S_{f} PRBs in the frequency domain, is given by:

$${R}_{{h}_{k}}^{h} ( t , f ) = \frac{1}{{N}_{pol} {N}_{v} {S}_{f}} {\sum }_{w ∈ {S}_{f}} {\sum }_{p = 1}^{{N}_{pol}} {\sum }_{r = 1}^{{N}_{v}} {a}_{k}^{r , p} ( t , w ) {{a}_{k}^{r , p} ( t , w )}^{H} ∈ {ℂ}^{{N}_{h} \times {N}_{h}} . \qquad ( 1 )$$

The vertical channel covariance matrix is given by:

$${R}_{{h}_{k}}^{v} ( t , f ) = \frac{1}{{N}_{pol} {N}_{h} {S}_{f}} {\sum }_{w ∈ {S}_{f}} {\sum }_{p = 1}^{{N}_{pol}} {\sum }_{c = 1}^{{N}_{h}} {b}_{k}^{c , p} ( t , w ) {{b}_{k}^{c , p} ( t , w )}^{H} ∈ {ℂ}^{{N}_{v} \times {N}_{v}} \qquad ( 2 )$$

where

$${a}_{k}^{r , p} ( t , f ) = {h}_{k} ( t , f ) [ ( [ 1 \text{:} {N}_{h} ] - 1 ) {N}_{v} + r + ( p - 1 ) {N}_{h} {N}_{v} ]$$

$${b}_{k}^{c , p} ( t , f ) = {h}_{k} ( t , f ) [ [ 1 \text{:} {N}_{v} ] + ( c - 1 ) {N}_{h} + ( p - 1 ) {N}_{h} {N}_{v} ] .$$

The long-term averaging with weighting factor α of the channel covariance matrix can be calculated as below:

$${\overline{R}}_{{h}_{k}}^{h} ( t , f ) = α {\sum }_{τ = 0}^{t - 1} {( 1 - α )}^{τ} {R}_{{h}_{k}}^{h} ( t - τ , f ) \qquad ( 3 )$$

$${\overline{R}}_{{h}_{k}}^{v} ( τ , f ) = α {\sum }_{τ = 0}^{t - 1} {( 1 - α )}^{τ} {R}_{{h}_{k}}^{v} ( t - τ , f ) . \qquad ( 4 )$$

### Where

$${\overline{R}}_{{h}_{k}}^{h} ( t , f )$$

represents the long-term average of the horizontal channel covariance matrix

$${R}_{{h}_{k}}^{h} ( t , f ) , and {\overline{R}}_{{h}_{k}}^{v} ( t , f )$$

represents the long-term average of the vertical channel covariance matrix

$${R}_{{h}_{k}}^{v} ( t , f ) .$$

In some embodiments, in the process 600, the first device 310 may determine the initial horizontal beam vector based on the following:

$${a}_{k}^{h} ( t , f ) = {max}_{{c}_{j} ∈ {C}^{h} , j = 1 , … , {N}_{h}} \{ {c}_{j}^{H} {\overline{R}}_{{h}_{k}}^{h} ( t , f ) {c}_{j} \} \qquad ( 5 )$$

where

$${a}_{k}^{h} ( t , f )$$

represents the initial horizontal beam vector, and Ch represents a codebook in horizontal domain.

In the process 600 or 800, the first device 310 may determine the initial vertical beam vector based on the following:

$${a}_{k}^{v} ( t , f ) = {max}_{{c}_{j} ∈ {C}^{v} , j = 1 , … , {N}_{v}} \{ {c}_{j}^{H} {\overline{R}}_{{h}_{k}}^{v} ( t , f ) {c}_{j} \} \qquad ( 6 )$$

### Where

$${a}_{k}^{v} ( t , f )$$

represents the initial vertical beam vector, and Ch represents a codebook in vertical domain.

In some embodiments, in order to further reduce the computational complexity and to enhance the estimation accuracy, instead of regular averaging calculations and vector multiplications as given by the above equations (1) to (4), the first device 310 may determine a second association between RSs previously received from the second device 320 as well as horizontal channel covariance matrices and vertical channel covariance matrices. The RSs comprises the first RS. In response to receiving the RS from the second device 320, the first device 310 may determine, based on the second association and the first reference signal, the horizontal channel covariance matrix and the vertical channel covariance matrix.

In such embodiments, ML based channel covariance calculation and prediction may be carried out. The functionality of this ML module is the joint channel estimation and covariance calculation/prediction. An input of the ML module may be the received SRS from a plurality of UEs and an output of the ML module may be the predicted horizontal and vertical channel covariance matrices (regression type output).

### Determination of the First Set of Candidate Horizontal Beams and the Second Set of Candidate Vertical Beams

As described with reference to FIG. 4, the first device 310 determines the first set of candidate horizontal beams by consecutively transforming the initial horizontal beam vector by the horizontal channel covariance matrix. For example, for simplicity, we denote the initial horizontal beam vector

$${a}_{k}^{h}$$

and the horizontal channel covariance matrix

$${\overline{R}}_{{h}_{k}}^{h}$$

as aₕ and Rₕ, respectively. Then, the first set of candidate horizontal beams may be represented by:

$${W}_{h} = [ {w}_{h , 1} , … , {w}_{h , {r}_{h}} ] = [ {a}_{h} , {R}_{h} {a}_{h} , … {R}_{h}^{{r}_{h} - 1} {a}_{h} ] \qquad ( 7 )$$

where rₕ represents an index of a power of the horizontal channel covariance matrix.

In addition, the first device 310 determines the second set of candidate vertical beams by consecutively transforming the initial vertical beam vector by the vertical channel covariance matrix. For example, we denote the initial vertical beam vector

$${a}_{k}^{v}$$

and the vertical channel covariance matrix

$${\overline{R}}_{{h}_{k}}^{v}$$

as aᵥ and Rᵥ, respectively. Then, the second set of candidate vertical beams may be represented by:

$${W}_{v} = [ {w}_{v , 1} , … , {w}_{v , {r}_{v}} ] = [ {a}_{v} , {R}_{v} {a}_{v} , … {R}_{v}^{{r}_{v} - 1} {a}_{v} ] \qquad ( 8 )$$

where rᵥ represents an index of a power of the vertical channel covariance matrix.

In some embodiments, the first device 310 may determine the first set of candidate horizontal beams by determining an index of a power of the horizontal channel covariance matrices to be zero and performing the following for a predetermined number of times: determining a product of a power of the horizontal channel covariance matrices and the initial horizontal beam vector; including the product into the first set of candidate horizontal beams; and increasing the index of the power by one. In some embodiments, the first device 310 may determine the second set of candidate vertical beams in a similar manner.

In some embodiments, the predetermined number is equal to or greater than the number of beamforming vectors in the beamforming matrix.

### Determination of the First Subset and the Second Subset

In some embodiments, the first device 310 may determine the first subset of the first set of candidate horizontal beams by selecting a first number of candidate horizontal beams from the first set. Indices of powers of the first number of candidate horizontal beams are greater than a threshold.

In some embodiments, a parallel beam selection approach could be applied. According to the parallel beam selection approach, the first device 310 may select the first number of candidate horizontal beams from the first set with higher power indices by W_{h,k}∈[w_{h,r}_{ₕ}_{-D+1}, . . . , w_{h,r}_{ₕ}], where D≤min{rᵥ,rₕ} represents the required number of beamforming vectors for each polarization, [w_{h,r}_{_{h-D+1}}, . . . , w_{h,r}_{ₕ}] represents the first subset.

Consider an example where the first set Wₕ comprises six candidate horizontal beams, i.e.,

$${W}_{h} = [ {w}_{h , 1} , … , {w}_{h , 6} ] = [ {a}_{h} , {R}_{h} {a}_{h} , … {R}_{h}^{5} {a}_{h} ] .$$

In this example, the threshold is equal to 1 and the first number is equal to 4. The first device 310 may select candidate horizontal beams

$${R}_{h}^{2} {a}_{h} , {R}_{h}^{3} {a}_{h} , {R}_{h}^{4} {a}_{h} , {R}_{h}^{5} {a}_{h}$$

from the first set Wₕ. Indices of powers of the four selected candidate horizontal beams are 2, 3, 4 and 5 respectively, which are greater than the threshold of 1.

In some embodiments, the first device 310 may determine the second subset of the second set of candidate vertical beams in a similar manner. For example, the first device 310 may select the first number of candidate vertical beams from the second set with higher power indices by, for example, w_{v,k}∈[w_{v,r}_{_{v-D+1}}, . . . , w_{v,r}_{ᵥ}], where D≤min{rᵥ,rₕ} represents the required number of beamforming vectors for each polarization, and [w_{v,r}_{ᵥ}_{-D+1}, . . . , w_{v,r}_{ᵥ}] represents the second subset.

In other embodiments, a cross beam selection approach could be applied. According to the cross beam selection approach, the first device 310 may select the first number Dₕ, 1≤Dₕ≤rₕ of candidate horizontal beams from the first set with higher power indices, and the second number Dᵥ, 1≤Dᵥ≤rᵥ of candidate vertical beams from the second set with higher power indices, where Dₕ≠Dᵥ holds. For example, the first set Wₕ comprises six candidate horizontal beams, i.e.,

$${W}_{h} = [ {w}_{h , 1} , … , {w}_{h , 6} ] = [ {a}_{h} , {R}_{h} {a}_{h} , … {R}_{h}^{5} {a}_{h} ]$$

and the first number Dₕ=4, indicating that the first device 310 may select candidate horizontal beams

$${R}_{h}^{2} {a}_{h} , {R}_{h}^{3} {a}_{h} , {R}_{h}^{4} {a}_{h} , {R}_{h}^{5} {a}_{h}$$

from the first set Wₕ. The second set Wᵥ comprises three candidate horizontal beams,

$${W}_{v} = [ {w}_{v , 1} , … , {w}_{v , 3} ] = [ {a}_{v} , {R}_{v} {a}_{v} , {R}_{v}^{2} {a}_{v} ]$$

and the second number Dᵥ=1, indicating that the first device 310 may select one candidate vertical beam

$${R}_{v}^{2} {a}_{v}$$

from the second set Wᵥ.

It shall be understood that other beam selection approaches may be also possible.

In some embodiments, upon determining the first and second subsets, the first device 310 may determine beamforming vectors by a Kronecker product of the first subset and the second subset. For example, the first device 310 may determine the beamforming vectors based on the following:

$${w}_{n} = {w}_{h , k} ⊗ {w}_{v , k} , n = 1 … , D , ∀ k ∈ \{ 1 … , D \} . \qquad ( 9 )$$

$${w}_{n} = {w}_{h , i} ⊗ {w}_{v , j} , n = 1 … , D , ∀ i ∈ \{ 1 … , {D}_{h} \} , ∀ j ∈ \{ 1 … , {D}_{ν} \} , D = {D}_{ν} {D}_{h} .$$

In turn, the first device 310 may determine a first beamforming matrix based on the beamforming vectors. For example, the first device 310 may determine a first beamforming matrix based on the following:

$${\overline{W}}_{D} = [ {w}_{1} , … , {w}_{D} ] \qquad ( 10 )$$

where W̅_{D} represents the first beamforming matrix.

In some embodiments, the first device 310 may determine the final beamforming matrix W_{D} by orthogonalization on W̅_{D}. For example, Gram-Schmidt orthogonalization procedure can be used.

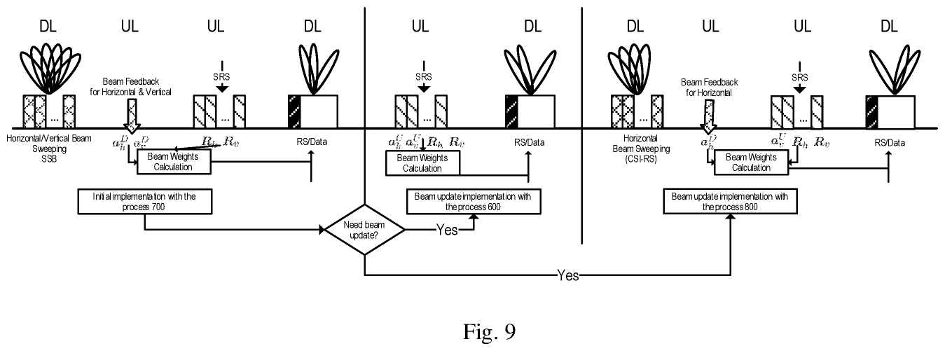

FIG. 9 illustrates a frame architecture to show an example implementation of the beamforming procedure in accordance with some example implementations of the present disclosure. The example implementation will be described with reference to the communication environment 300 of FIG. 3. However, the example implementation may be likewise applied to other communication scenarios.

In an initial access, the process 700 may be performed considered. The first device 310 performs a beam sweeping for horizontal and vertical dimensions via SSB (block 710), and the second device 320 measures the received signal quality and feeds back to the first device 310 indices of its best horizontal and vertical beams (i.e., the initial horizontal and vertical beam vectors) (block 720). The first device 310 receives the indices of the initial horizontal and vertical beam vectors and determines the initial horizontal and vertical beam vectors

$${a}_{h}^{D} and {a}_{v}^{D}$$

based on the indices (blocks 730 and 740).

Meanwhile, the first device 310 determines the horizontal and vertical channel covariance matrices Rₕ and Rᵥ (blocks 620 and 630) based on the received SRS. The initial horizontal and vertical beam vectors

$${a}_{h}^{D} and {a}_{v}^{D}$$

as well as the channel covariance matrices Rₕ and Rᵥ are used to determine the beamforming matrix. Then, the RS or data may be transmitted via the beamforming matrix.

Due to time aging, the first device 310 needs to update the beams. In this case, the process 600 and the process 800 may be applied. For example, in the middle phase of the frame illustration (the process 600), the first device 310 may trigger an additional SRS so that the initial horizontal and vertical beam vectors as well as the channel covariance matrices may be updated. As a result, the first device 310 determines the updated initial horizontal and vertical beam vectors

$${a}_{h}^{U} and {a}_{v}^{U}$$

and the updated channel covariance matrices Rₕ and Rᵥ.

Recalculation of the beamforming matrix may be carried out for a next RS or data transmission. In the case where additional beam sweeping is needed for CSI update, the first device 310 may trigger the CSI-RS using horizontal and/or vertical beam sweeping procedure. In phase 3 (implementation of the process 800) of FIG. 9, only the horizontal beam sweeping is considered as one example. The initial vertical beam vector is updated from the uplink SRS. Similarly, the recalculation of the beamforming matrix is implemented for a new RS or data transmission.

### Simulation Results

We evaluate the performance of the beamforming procedure in accordance with some example implementations of the present disclosure and compare it with different standard methods, where zero-forcing precoding is considered for all the cases. FIGS. 10 A and 10B illustrate spectral efficiency performance of various schemes for beamforming. FIG. 10 A is for the Uma scenario and FIG. 10 B is for the Umi scenario. In the FIGS. 10 A and 10B, SNR=10 dB.

As shown, the “Best EBF” is the upper bound solution, using one standard full version of the EVD with power iterations, i.e., Full Gram-Schmidt Eigen Value Decomposition (Full GSEVD), to calculate full eigen beams directly, which is shown by 1010, 1020, 1030, 1040, 1050, 1060, 1070 and 1080. The horizontal-vertical EBF “I-EBF” is also considered, which is shown by 1012, 1022, 1032, 1042, 1052, 1062, 1072 and 1082. For both full EBF and I-EBF, the number of iterations of 4 is chosen. The “I-KSB” refers to the beamforming procedure in accordance with some example implementations of the present disclosure, which is shown by 1014, 1024, 1034, 1044, 1054, 1064, 1074 and 1084. In the “I-KSB”, the initial horizontal and vertical beam vectors are obtained by equations (5) and (6) from the DFT codebook with an oversampling factor 4. The channel parameters as well as the array geometry used are listed in Table 2.

TABLE 2
Simulation Parameters

| | |
|---|---|
| Channel model | sub-6 GHz in 3GPP TR 38.901 |
| Scenario | NR-Umi/Uma |
| Carrier frequency (DL) | 2.15 GHz |
| Bandwidth | 20 MHz |
| BS Tx Antenna | 192 AEs (12 × 8 × 2)→ 64 TXRUs (4 × 8 × 2) |
| UE Rx Antenna | 2 AEs ports (1 × 1 × 2) |
| # of streams/UE | 2-layer transmission |

We can observe from FIGS. 10 A and 10B that in both Uma and Umi scenarios, the proposed horizontal-vertical beamforming algorithm (‘I-KSB’) performs closely to the full EBF solution (less than 2% loss), and has almost the same performance as I-EBF with only 01% performance loss at geometric mean and may outperform at cell-edge.

### Computational Complexity Analysis

The computational complexity of the beamforming procedure in accordance with some example implementations of the present disclosure is compared with that of the horizontal-vertical EBF counterpart.

The computational complexity of the subspace method proposed in the present disclosure comes from the construction of the beamforming matrix in equation (1) and the orthogonalization. The computational complexity refers to the number of complex multiplications, and the number of complex additions is trivial and thus neglected. We denote the number of beamforming vectors for horizontal and vertical as rₕ, rᵥ, the matrix dimension as N=NₕNᵥ, and the number of iterations for the power iterative based EVD as J.

Table 3 shows the complexity calculation for two different schemes.

TABLE 3

| | Computational Complexity (# of complex multiplications) |
|---|---|
| I-EBF | ${r}_{v} \cdot ( ( J + 2 ) {N}_{v}^{2} + ( 4 J + 1 ) {N}_{v} + J ) + {r}_{h} \cdot ( ( J + 2 ) {N}_{h}^{2} + ( 4 J + 1 ) {N}_{h} + J ) + ( 2 {N}_{v} {N}_{h} + 3 \cdot \frac{{N}_{v} {N}_{h}}{2} ) \cdot D$ |
| I-KSB | $( {r}_{v} - 1 ) {N}_{v}^{2} + ( {r}_{h} - 1 ) {N}_{h}^{2} + DN + ( \frac{3 N ( D - 1 ) D}{2} + 2 DN )$ |

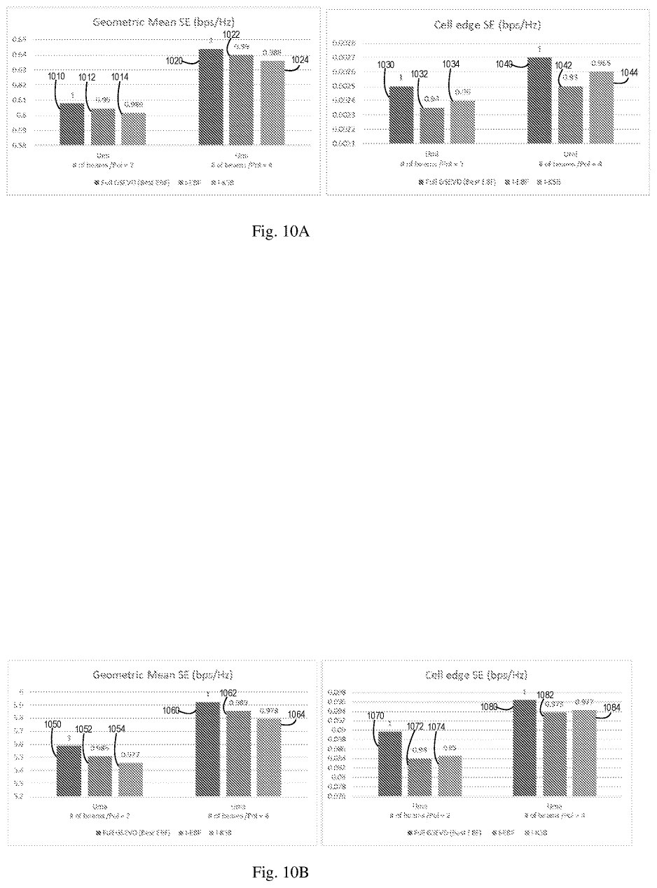

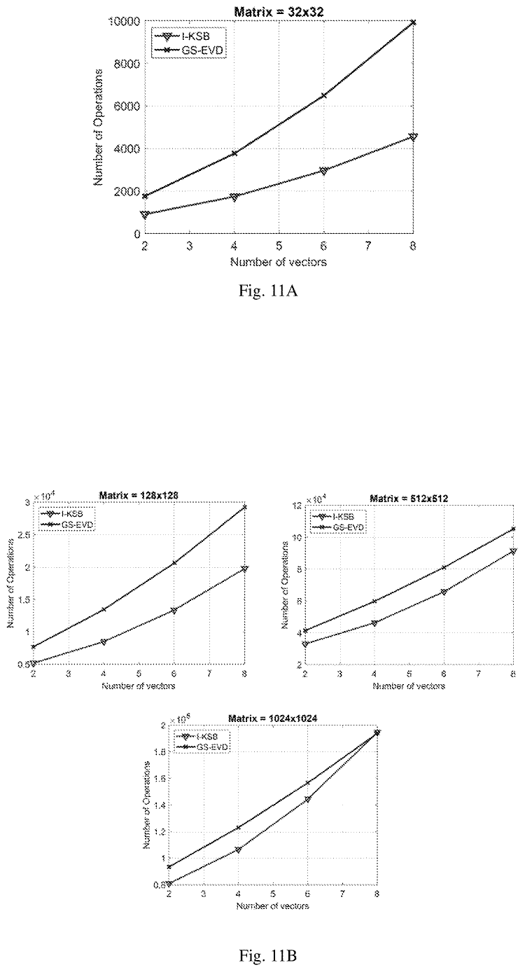

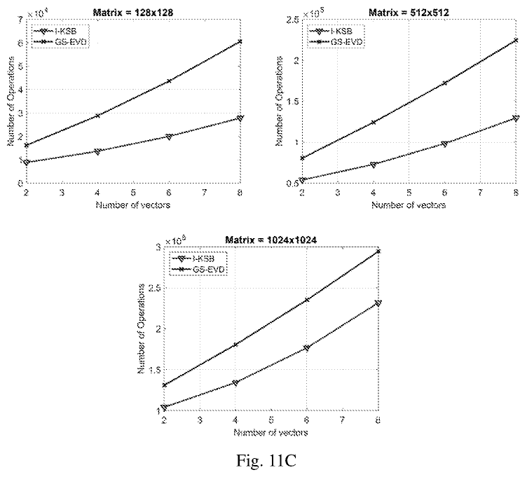

FIG. 11A illustrates computational complexity for different schemes for the above simulation setup.

FIGS. 11B and 11C illustrate computational complexity for different schemes using different sizes of the matrix. In FIG. 11B, array dimensions of (8×16), (16×32) and (32×32) (more squared) are applied. In FIG. 11C, array dimensions of (4×32), (8×64) and (16×64) (higher aspect ratio) are applied. In FIGS. 11B and 11C, the computational complexity curves are illustrated as a function of the number of full beamforming vectors, where the iteration number for EVD is fixed as 4. It can be observed that the I-KSB has only <50% complexity compared with I-EBF. For larger arrays as shown in FIGS. 11B and 11C, I-KSB is more advantageous for array with a higher aspect ratio, 20%-50% complexity reduction can be obtained by I-KSB.

Therefore, it can be concluded that the proposed beamforming algorithm has a similar performance as I-EBF with around 1% performance loss while has a much lower implementation complexity (i.e., about 50% complexity reduction) as compared to the low-complexity EBF variant.

In some example implementations, an apparatus capable of performing any of the method 400 (for example, the first device 310) may comprise means for performing the respective steps of the method 400. The means may be implemented in any suitable form. For example, the means may be implemented in a circuitry or software module.

In some example implementations, the apparatus comprises: means for determining, at a first device, a first set of candidate horizontal beams by consecutively transforming an initial horizontal beam vector by a horizontal channel covariance matrix; means for determining a second set of candidate vertical beams by consecutively transforming an initial vertical beam vector by a vertical channel covariance matrix; and means for determining a beamforming matrix for communication with a second device based on a first subset of the first set and a second subset of the second set.

In some example implementations, the apparatus further comprises: means for receiving a reference signal from the second device; and means for determining the initial horizontal beam vector and the initial vertical beam vector based on the reference signal.

In some example implementations, the apparatus further comprises: means for determining the initial horizontal beam vector and the initial vertical beam vector by: performing a horizontal beam sweeping and a vertical beam sweeping to the second device; receiving, from the second device, a first index of the initial horizontal beam vector and a second index of the initial vertical beam vector; and determining the initial horizontal beam vector and the initial vertical beam vector based on the first index and the second index, respectively.

In some example implementations, the apparatus further comprises: means for determining the initial horizontal beam vector by: performing a horizontal beam sweeping to the second device; receiving, from the second device, a first index of the initial horizontal beam vector; determining the initial horizontal beam vector based on the first index; and means for determining the initial vertical beam vector by: receiving a reference signal from the second device; and determining the initial vertical beam vector based on the reference signal.

In some example implementations, the apparatus further comprises: means for determining the initial vertical beam vector by: performing a vertical beam sweeping to the second device; receiving, from the second device, a second index of the initial vertical beam vector; determining the initial vertical beam vector based on the second index; and means for determining the initial horizontal beam vector by: receiving a reference signal from the second device; and determining the initial horizontal beam vector based on the reference signal.

In some example implementations, the means for determining the first set of candidate horizontal beams comprises: means for determining an index of a power of the horizontal channel covariance matrices to be zero; and means for performing the following for a predetermined number of times: determining a product of a power of the horizontal channel covariance matrices and the initial horizontal beam vector; including the product into the first set of candidate horizontal beams; and increasing the index of the power by one. In such example implementations, the apparatus further comprises means for determining the first subset of the first set of candidate horizontal beams by: selecting a first number of candidate horizontal beams from the first set, indices of powers of the first number of candidate horizontal beams being greater than a threshold.

In some example implementations, the predetermined number is equal to or greater than the number of beamforming vectors in the beamforming matrix.

In some example implementations, the means for determining at least one of the first set of candidate horizontal beams and the second set of candidate vertical beams comprises: means for determining a first association between uplink channel information previously received from a third plurality of devices and predetermined beamforming procedures to be applied to the third plurality of devices; means for determining, based on the first association and uplink channel information received from the second device, a first beamforming procedure among the predetermined beamforming procedures which is to be applied to the second device; and means for determining the at least one of the first set of candidate horizontal beams and the second set of candidate vertical beams by performing the first beamforming procedure.

In some example implementations, the apparatus further comprises: means for determining a second association between reference signals previously received from the second device as well as horizontal channel covariance matrices and vertical channel covariance matrices; means for receiving a first reference signal from the second device, the reference signals comprising the first reference signal; and means for determining, based on the second association and the first reference signal, the horizontal channel covariance matrix and the vertical channel covariance matrix.

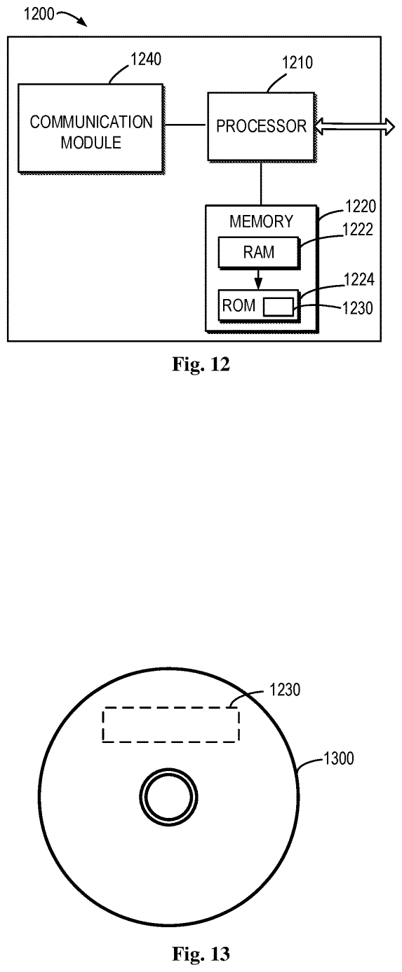

FIG. 12 is a simplified block diagram of a device 1200 that is suitable for implementing embodiments of the present disclosure. The device 1200 may be provided to implement the communication device, for example, the first device 310 or the second device 320 as shown in FIG. 3. As shown, the device 1200 includes one or more processors 1210, one or more memories 1220 coupled to the processor 1210, and one or more communication modules 1240 coupled to the processor 1210.

The communication module 1240 is for bidirectional communications. The communication module 1240 has at least one antenna to facilitate communication. The communication interface may represent any interface that is necessary for communication with other network elements.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1230 so that the device 1200 may perform any process of the disclosure as discussed with reference to FIGS. 1 to 11. The embodiments of the present disclosure may also be implemented by hardware or by a combination of software and hardware.

In some example embodiments, the program 1230 may be tangibly contained in a computer readable medium which may be included in the device 1200 (such as in the memory 1220) or other storage devices that are accessible by the device 1200. The device 1200 may load the program 1230 from the computer readable medium to the RAM 1222 for execution. The computer readable medium may include any types of tangible non-volatile storage, such as ROM, EPROM, a flash memory, a hard disk, CD, DVD, and the like. FIG. 13 shows an example of the computer readable medium 1300 in form of CD or DVD. The computer readable medium has the program 1230 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
wherein the at least one memory and the computer program code are configured to, with the at least one processor, cause the first device to:
determine a first set of candidate horizontal beams by consecutively transforming an initial horizontal beam vector by a horizontal channel covariance matrix;
determine a second set of candidate vertical beams by consecutively transforming an initial vertical beam vector by a vertical channel covariance matrix; and
determine a beamforming matrix for communication with a second device based on a first subset of the first set and a second subset of the second set.

2. The first device of claim 1, wherein the first device is further caused to:
receive a reference signal from the second device; and
determine the initial horizontal beam vector and the initial vertical beam vector based on the reference signal.

3. The first device of claim 1, wherein the first device is further caused to determine the initial horizontal beam vector and the initial vertical beam vector by:
performing a horizontal beam sweeping and a vertical beam sweeping to the second device;
receiving, from the second device, a first index of the initial horizontal beam vector and a second index of the initial vertical beam vector; and
determining the initial horizontal beam vector and the initial vertical beam vector based on the first index and the second index, respectively.

4. The first device of claim 1, wherein the first device is further caused to:
determine the initial horizontal beam vector by:
performing a horizontal beam sweeping to the second device;
receiving, from the second device, a first index of the initial horizontal beam vector;
determining the initial horizontal beam vector based on the first index; and
determine the initial vertical beam vector by:
receiving a reference signal from the second device; and
determining the initial vertical beam vector based on the reference signal.

5. The first device of claim 1, wherein the first device is further caused to:
determine the initial vertical beam vector by:
performing a vertical beam sweeping to the second device;
receiving, from the second device, a second index of the initial vertical beam vector;
determining the initial vertical beam vector based on the second index; and
determine the initial horizontal beam vector by:
receiving a reference signal from the second device; and
determining the initial horizontal beam vector based on the reference signal.

6. The first device of claim 1, wherein the first device is caused to determine the first set of candidate horizontal beams by:
determining an index of a power of the horizontal channel covariance matrices to be zero; and
performing the following for a predetermined number of times:
determining a product of a power of the horizontal channel covariance matrices and the initial horizontal beam vector;
including the product into the first set of candidate horizontal beams; and
increasing the index of the power by one; and
wherein the first device is further caused to determine the first subset of the first set of candidate horizontal beams by:
selecting a first number of candidate horizontal beams from the first set, indices of powers of the first number of candidate horizontal beams being greater than a threshold.

7. The first device of claim 6, wherein the predetermined number is equal to or greater than the number of beamforming vectors in the beamforming matrix.

8. The first device of claim 1, wherein the first device is caused to determine at least one of the first set of candidate horizontal beams and the second set of candidate vertical beams by:
determining a first association between uplink channel information previously received from a third plurality of devices and predetermined beamforming procedures to be applied to the third plurality of devices;
determining, based on the first association and uplink channel information received from the second device, a first beamforming procedure among the predetermined beamforming procedures which is to be applied to the second device; and
determining the at least one of the first set of candidate horizontal beams and the second set of candidate vertical beams by performing the first beamforming procedure.

9. The first device of claim 1, wherein the first device is further caused to:
determine a second association between reference signals previously received from the second device as well as horizontal channel covariance matrices and vertical channel covariance matrices;
receive a first reference signal from the second device, the reference signals comprising the first reference signal; and
determine, based on the second association and the first reference signal, the horizontal channel covariance matrix and the vertical channel covariance matrix.

10. A method, comprising:
determining, at a first device, a first set of candidate horizontal beams by consecutively transforming an initial horizontal beam vector by a horizontal channel covariance matrix;
determining a second set of candidate vertical beams by consecutively transforming an initial vertical beam vector by a vertical channel covariance matrix; and
determining a beamforming matrix for communication with a second device based on a first subset of the first set and a second subset of the second set.

11. The method of claim 10, further comprising:
receiving a reference signal from the second device; and
determining the initial horizontal beam vector and the initial vertical beam vector based on the reference signal.

12. The method of claim 10, further comprising:
determining the initial horizontal beam vector and the initial vertical beam vector by:
performing a horizontal beam sweeping and a vertical beam sweeping to the second device;
receiving, from the second device, a first index of the initial horizontal beam vector and a second index of the initial vertical beam vector; and
determining the initial horizontal beam vector and the initial vertical beam vector based on the first index and the second index, respectively.

13. The method of claim 10, further comprising:
determining the initial horizontal beam vector by:
performing a horizontal beam sweeping to the second device;
receiving, from the second device, a first index of the initial horizontal beam vector;
determining the initial horizontal beam vector based on the first index; and
determining the initial vertical beam vector by:
receiving a reference signal from the second device; and
determining the initial vertical beam vector based on the reference signal.

14. The method of claim 10, further comprising:
determining the initial vertical beam vector by:
performing a vertical beam sweeping to the second device;
receiving, from the second device, a second index of the initial vertical beam vector;
determining the initial vertical beam vector based on the second index; and
determining the initial horizontal beam vector by:
receiving a reference signal from the second device; and
determining the initial horizontal beam vector based on the reference signal.

15. The method of claim 10, wherein determining the first set of candidate horizontal beams comprises:
determining an index of a power of the horizontal channel covariance matrices to be zero; and
performing the following for a predetermined number of times:
determining a product of a power of the horizontal channel covariance matrices and the initial horizontal beam vector;
including the product into the first set of candidate horizontal beams; and
increasing the index of the power by one; and
wherein the method further comprises determining the first subset of the first set of candidate horizontal beams by:
selecting a first number of candidate horizontal beams from the first set, indices of powers of the first number of candidate horizontal beams being greater than a threshold.

16. The method of claim 15, wherein the predetermined number is equal to or greater than the number of beamforming vectors in the beamforming matrix.

17. The method of claim 10, wherein determining at least one of the first set of candidate horizontal beams and the second set of candidate vertical beams comprises:
determining a first association between uplink channel information previously received from a third plurality of devices and predetermined beamforming procedures to be applied to the third plurality of devices;
determining, based on the first association and uplink channel information received from the second device, a first beamforming procedure among the predetermined beamforming procedures which is to be applied to the second device; and
determining the at least one of the first set of candidate horizontal beams and the second set of candidate vertical beams by performing the first beamforming procedure.

18. The method of claim 10, further comprising:
determining a second association between reference signals previously received from the second device as well as horizontal channel covariance matrices and vertical channel covariance matrices;
receiving a first reference signal from the second device, the reference signals comprising the first reference signal; and
determining, based on the second association and the first reference signal, the horizontal channel covariance matrix and the vertical channel covariance matrix.

19. (canceled)

20. A computer readable medium comprising program instructions for causing an apparatus to perform the method of claim 10.
